(19) United States
(12) Patent Application Publication
(10) Pub. No.: US 2016/0088520 A1
(43) Pub. Date: Mar. 24, 2016

(54) INFORMATION PROCESSING DEVICE, COMMUNICATION APPARATUS, TERMINAL, COMMUNICATION PROCESSING METHOD, AND NON-TRANSITORY COMPUTER READABLE MEDIUM

(71) Applicant: KABUSHIKI KAISHA TOSHIBA, Tokyo (JP)

(72) Inventors: Yuichiro OYAMA, Tokyo (JP); Takeshi ISHIHARA, Yokohama (JP); Hiroshi NISHIMOTO, Yokohama (JP)

(21) Appl. No.: 14/857,025

(22) Filed: Sep. 17, 2015

(30) Foreign Application Priority Data
Sep. 18, 2014 (JP) 2014-190426

(51) Int. Cl. H04W 28/08; H04W 48/18; H04W 36/00

(52) U.S. Cl. CPC H04W 28/08; H04W 36/0022; H04W 48/18; H04W 84/12

(57) ABSTRACT

According to one embodiment, an information processing device includes a first circuitry and a second circuitry. The first circuitry specifies information potential to be requested by an application and acquires the information over a network before the information is requested by the application. The second circuitry controls operation of the first circuitry based on a parameter value obtained by measuring a surrounding communication environment or an evaluation value depending on the parameter value.

### CROSS-REFERENCE TO RELATED APPLICATIONS

This application is based upon and claims the benefit of priority from Japanese Patent Application No. 2014-190426, filed Sep. 18, 2014; the entire contents of which are incorporated herein by reference.

### FIELD

Embodiments described herein relate to an information processing device, a communication apparatus, a terminal, a communication processing method, and a non-transitory computer readable medium.

### BACKGROUND

A technique is known, in which a communication request made by an application is temporarily saved, and the communication request is fulfilled when the communication request is determined to be feasible. In addition, a method is known, in which, at the time of off-loading from a mobile telephone network having a heavy traffic to a wireless LAN network, a certain time period is waited until communication using a wireless LAN is enabled, and an upper limit for the waiting time is set. In addition, a technique is known, in which information that is expected to be used afterward is subjected to pre-acquisition when a wireless LAN communication that has a higher communication efficiency than a mobile telephone network.

However, in the case of waiting for a certain time period until communication using a wireless LAN is enabled, a waiting time is unclear or a fixed value, which disables flexible determination of communication approval/disapproval. For example, during waiting, data may be exchanged using a mobile telephone network having a heavy traffic without performing communication using a wireless LAN although a wireless LAN area, having a value that is slightly less than a reference value for the communication approval determination, is detected. As a result, a long time is waited to start communication, and consumed energy is increased.

Meanwhile, as to the technique of the pre-acquisition, there is a risk that information is endlessly subjected to pre-acquisition in the situation where wireless LAN communication can be stably used. As a result, in the case of a battery-driven device, there is a risk of consuming energy accumulated in a battery more than necessary, shortening a running time.

### BRIEF DESCRIPTION OF THE DRAWINGS

FIG. 1 is a functional block diagram of a communication apparatus in which an information processing device in an embodiment of the present invention is installed;

FIG. 2 is a functional block diagram showing a sensor installed in the communication apparatus in FIG. 1;

FIG. 3 is a flow chart of a first operation example in a first embodiment;

FIG. 4 is a state transition diagram of a pre-acquisition operation in the communication apparatus;

FIG. 5 is a diagram showing a flow chart of a second operation example in the first embodiment;

FIG. 6 is a state transition diagram corresponding to the operation of FIG. 5;

FIG. 7 is a dialog showing a flow chart of the operation of a pre-acquisition unit;

FIG. 8 is a diagram showing a flow chart of the detailed operation of step S602 in FIG. 7;

FIG. 9 is a diagram for illustrating a specific example of the operation of the first embodiment;

FIG. 10 is a functional block diagram of a communication apparatus in which an information processing device in a second embodiment is installed;

FIG. 11 is a diagram for illustrating a specific example of the operation of a second embodiment;

FIG. 12 is a diagram for illustrating another specific example of the operation of the second embodiment;

FIG. 13 is a diagram for illustrating still another specific example of the operation of the second embodiment;

FIG. 14 is a functional block diagram of a communication apparatus in which an information processing device in a third embodiment is installed; and

FIG. 15 is a diagram showing a terminal in which an information processing device in a fifth embodiment is installed.

### DETAILED DESCRIPTION

According to one embodiment, an information processing device includes a first circuitry and a second circuitry. The first circuitry specifies information potential to be requested by an application and acquires the information over a network before the information is requested by the application. The second circuitry controls operation of the first circuitry based on a parameter value obtained by measuring a surrounding communication environment or an evaluation value depending on the parameter value.

Embodiments of the present invention will be described below with reference to the drawings. The embodiments to be described below are merely an example, and the present invention is not necessarily implemented in the same forms as them. In addition, in the drawings, the same component will be denoted by the same reference numeral, and the description thereof will be omitted as appropriate.

### First Embodiment

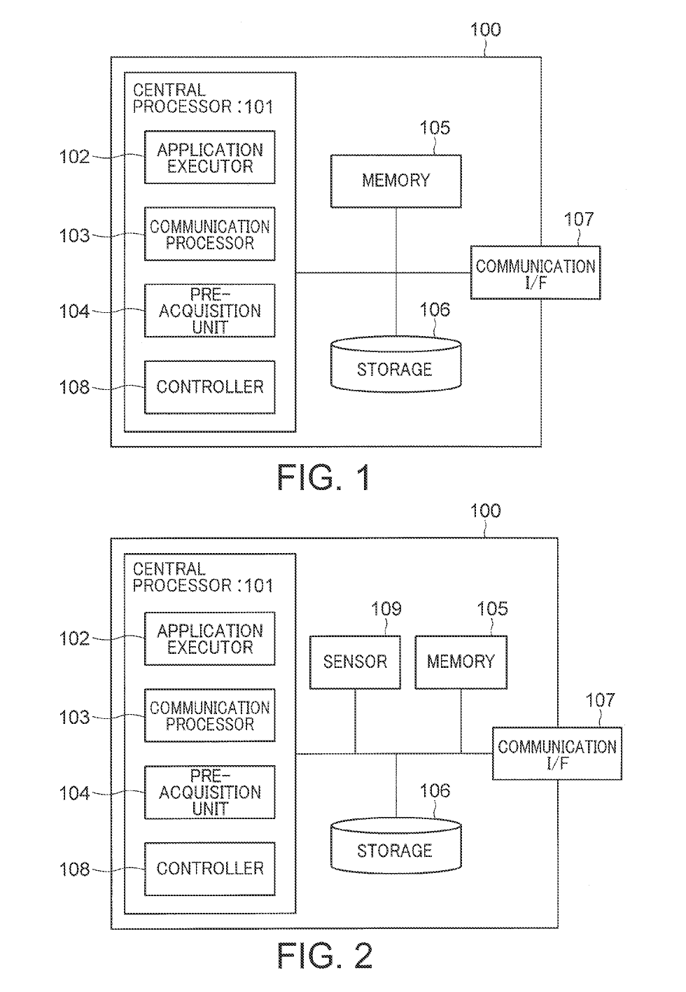

FIG. 1 shows a functional block diagram of a communication apparatus in which an information processing device in an embodiment of the present invention is installed. Note that FIG. 1 shows only elements necessary for the description of the present application, not intending to exclude the existence of the other elements.

A communication apparatus 100 includes a central processor 101, a memory 105, a storage 106, and a communication I/F 107. The central processor 101 is equivalent to the information processing device in the present embodiment.

The central processor (information processing device) 101 is a central processor that manages the operation of this apparatus, and includes an application executor 102, a communication processor 103, a pre-acquisition unit 104, and a controller 108.

The application executor 102, the communication processor 103, the pre-acquisition unit 104, and the controller 108 may be formed as individual hardware elements or may be implemented by software that runs on a processor such as a CPU. The central processor 101, the application executor 102, a communication processor 103, a pre-acquisition unit 104, and a controller 108 can implemented by circuitry such as a processor or an integrated circuit. Each circuitry which implements the central processor 101, the application executor 102, a communication processor 103, a pre-acquisition unit 104, and a controller 108 may be different physical circuitry or all or a part of them may be same physical circuitry such as a CPU. The central processor 101 may be processing circuitry in which the application executor 102, a communication processor 103, a pre-acquisition unit 104, and a controller 108 are implemented. The storage 106 may be configured by any storage device such as a memory or storage. The memory may be volatile memory such as SRAM or DRAM, or non-volatile memory such as NAND, FRAM or MRAM. The storage may generally be any device which can memorize data permanently such as an HDD, an optical disc or SSD. The term “circuitry” may indicate one circuit, a plurality of circuits, or a system of circuits.

The application executor 102 has charge of the execution of applications (e.g., a web browser, news application, map application, movie player, and music player) that run on the communication apparatus 100.

The communication processor 103 performs a communications protocol such as TCP/IP. The application executor 102 and the pre-acquisition unit 104 (which will be described below) perform information acquisition over a network using the communication processor 103.

The pre-acquisition unit 104 acquires, based on an instruction from an application running on the application executor 102 or instructions from an external server over a network, information that may be referred to afterward (i.e., information that the application may request to be acquired afterward). For example, the application executor 102 specifies a link destination such as a URL contained in an HTML file that is acquired with the request from itself, and instructs the pre-acquisition unit 104 to acquire information being the specified link destination. The request to acquire the information in question is fulfilled, for example, when the link is specified by a user, but the information in question is acquired in advance before such an instruction is received. The information subjected to the pre-acquisition is, as will be described below, is stored in the memory 105 or the storage 106 being associated with an identifier such as a URL.

In addition, the pre-acquisition unit 104 may have a function that independently analyzes the information that is acquired in response to a request from an application running on the application executor 102 and autonomously acquired information that may be referred to afterward. For example, the function may receive an HTML file that is acquired in response to a request from the application executor 102, specify a link destination such as a URL, and acquire information being the link destination over a network. In this case, the application executor 102 may output an acquiring request for the information to the pre-acquisition unit 104, the pre-acquisition unit 104 may transmit the information (e.g., an HTML file) acquired in response to the acquiring request to the application executor 102 as a response. If information requested by the application executor 102 has already been acquired in advance, the pre-acquisition unit 104 can read out the information from the memory 105 or the storage 106 and transmit it as a response.

The memory 105 is a volatile memory a such as a DRAM or a nonvolatile memory such as a MRAM, being a storage to temporarily store programs to be executed by the central processor 101, various kinds of data, and the like.

The storage 106 is a storage to permanently save the programs to be executed by the central processor 101 or the various kinds of data. The storage 106 is formed by, for example, an HDD (hard disk drive) or an SSD (solid state drive).

The communication I/F 107 is an interface to exchange, with a network, information strings that are formed in conformity with a communications protocol (e.g., TCP/IP) performed by the communication processor 103. Examples of the network include cellular communication technologies such as an LTE, CDMA or GSM, and WiMAX, or wireless LANs following IEEE 802.11.

The controller 108 has a function that is roughly divided into two functions.

First, the controller 108 controls (changes) a condition used to determine whether the pre-acquisition unit 104 performs the pre-acquisition.

Second, the controller 108 performs at least one of grasping a surrounding communication environment and grasping the current state of the communication apparatus (apparatus state), and determines the approval/disapproval for the pre-acquisition based on at least one of the communication environment and the current state. The communication environment can be grasped by measuring a parameter value such as an RSSI and an SN ratio using the communication I/F 107. Grasping the communication environment using a sensor is also possible. In this case, as shown in FIG. 2, the sensor 109 may be installed in the communication apparatus 100. The sensor 109 is a sensor of acceleration, sound, luminous strength, magnetism, current/voltage, or the like. The operation of the sensor 109 can be controlled by the central processor 101. In addition, the apparatus state can be grasped using the sensor 109. For example, using the sensor 109, it can be determined whether power is supplied from a temporal power source means such as a battery or a permanent power source means such as an AC adapter.

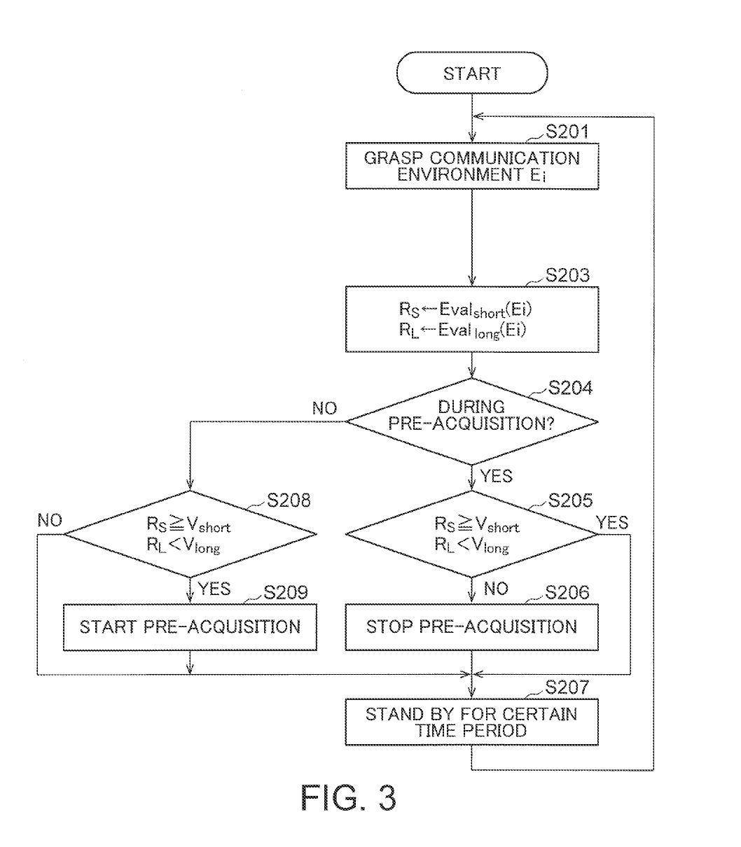

FIG. 3 shows a flow chart of a first operation example in a first embodiment. As a prerequisite, the process of this flow chart is assumed to be performed concurrently with the pre-acquisition process by the pre-acquisition unit 104 (including a time division manner). It is assumed here the case where only the communication environment is grasped out of the communication environment and the apparatus state. First, a communication environment Eᵢ is grasped (the parameter value of the communication environment is measured) (S201). Then, based on the grasped current communication environment Eᵢ, an evaluation value of the current communication environment is calculated. The value of the communication environment Eᵢ (the measured value of the parameter) itself may be treated as the evaluation value, a value converted into one within a predetermined range (e.g., a range between 0 and 100) may be determined as the evaluation value. When the evaluation value is calculated, a short-term comprehensive evaluation value and a long-term comprehensive evaluation value are calculated using the calculated evaluation value and a past calculated evaluation value.

That is, a comprehensive evaluation function Evalₛₕₒᵣₜ( ) based on short-term changes and a comprehensive evaluation function Eval_{long}( ) based on long-term changes are calculated. These two functions are for outputting the short-term comprehensive evaluation value and the long-term comprehensive evaluation value that represent how far the current condition is suitable for communication based on the current and past evaluation values of the communication environment (e.g., an integer between 0 and 100, a larger one represents a more suitable condition). A difference between the short-term one and the long-term one is in, for example, the number of past data items to be referred to, and the short-term evaluation function uses a smaller number of data items than the long-term evaluation function. The output value of the short-term evaluation function Evalₛₕₒᵣₜ( ) is defined as a short-term comprehensive evaluation value Rₛ, and the output value of the long-term evaluation function Eval_{long}( ) is defined as a long-term comprehensive evaluation value R_{L}.

For example, in the case of the short-term evaluation function, using Ej (j=i, i−1, . . . , i−4), the moving average of past five data items is calculated as the short-term comprehensive evaluation value Rs, and in the case of the long-term evaluation function, using Ej (j=i, i−1, . . . , i−19), the moving average of past 20 data items is calculated as the long-term comprehensive evaluation value RL. To calculate the moving averages, inputs of the functions (evaluation values) may be properly weighted to calculate the function in the form of a weighted moving average or an exponential moving average.

A specific example of the evaluation functions Evalₛₕₒᵣₜ( ) and Eval_{long}( ) will be shown. Consider the case where the communication environment Eᵢ is the strength of a radio wave received from a wireless LAN access point (RSSI).

In this case, an evaluation function can be designed by which an evaluation value is calculated from the values of the communication environment Eᵢ, the evaluation value taking zero for a lower limit strength at which communication is disabled, and taking 100 for a supposed maximum strength, and the average of current and past evaluation values is output. The same is true for the case where the communication environment Eᵢ consists of a plurality of parameters.

For example, in the case where the communication environment Eᵢ is defined by a received radio field strength (RSSI) and a signal-to-noise ratio (SNR), each of them may be scored between 0 and 100, the average value of which may be determined as the evaluation value. Additionally, a score can be determined with respect to the combination of an RSSI and an SNR in advance for each communication/encoding schemes (e.g., 256QAM or 64QAM) to be used, the average value of which is determined as the evaluation value.

Return to the description of the flow chart. It is determined in S204 whether the pre-acquisition unit 104 is in a pre-acquisition operation. If the pre-acquisition unit 104 is in the pre-acquisition operation (S204-YES), the flow proceeds to step S205. In S205, the determination about the approval/disapproval for the pre-acquisition is made based on the short- and long-term comprehensive evaluation values. If the short-term comprehensive evaluation value Rₛ is more than or equal to a reference value (threshold value) Vshort and the long-term comprehensive evaluation value is less than a reference value (threshold value) Vlong (S205-YES), the pre-acquisition is approved. That is, the status quo of the current pre-acquisition operation is determined, and after standby for a certain time period (S207), the flow returns to the first step S201.

Here, if the short-term comprehensive evaluation value Rₛ is more than or equal to the reference value Vshort, it can be said that the communication environment is in a state suitable for communication from a short-term perspective. If the short-term comprehensive evaluation value Rₛ is less than the reference value Vshort, it can be said that the communication environment is in a state unsuitable for communication from a short-term perspective. If the long-term comprehensive evaluation value is more than or equal to the reference value Vlong, it can be said that the communication environment is in a state suitable for communication from a long-term perspective. If the long-term comprehensive evaluation value is less than the reference value Vlong, it can be said that the communication environment is in a state unsuitable for communication from a long-term perspective. It is determined here that the communication environment is in a state suitable for communication if the short- or long-term comprehensive evaluation value is more than or equal to the threshold value (reference value), but it may be determined, depending on the parameter value of the communication environment to be measured, that the communication environment is in a state suitable for communication if the value is less than a threshold value. For example, in the case where environmental noise is measured as the communication environment, if the short- and long-term comprehensive evaluation values that are calculated from an evaluation value group according to the value of environmental noise is less than the threshold value, it may be determined that a state the communication environment is suitable for communication, respectively.

If the above-mentioned condition is not satisfied (S205-NO), that is, if the short-term comprehensive evaluation value Rₛ is less than the reference value Vshort, or if the long-term comprehensive evaluation value R_{L} is more than or equal to the reference value Vlong, it is determined that the pre-acquisition is disapproved, and the pre-acquisition is stopped (S206). Then, after the standby for a certain time period (S207), the flow returns to the first step (S201).

If the pre-acquisition unit 104 is not in pre-acquisition operation (S204-NO), the flow proceeds to S208. In S208, determination similar to that in S205 is performed. If the above-mentioned condition is satisfied (S208-YES), the pre-acquisition is started (S209), and after the standby for a certain time period (S207), the flow returns to the first step S201. If the condition is not satisfied (S208-NO), the status quo is determined, and after the standby for a certain time period (S207), the flow returns to the first step S201.

In a series of descriptions, the expressions “the pre-acquisition is started” (S209) and “the pre-acquisition is stopped (S206)” are used, but a point in the course of the pre-acquisition process at which the pre-acquisition is performed or stopped depends on implementations. As mentioned above, since the pre-acquisition process and a determination process about the start or the stop are independently operated, the processes for start and stop are implemented in the form of, for example, in the case of implementation by software, starting and stopping a process or a thread, and of exchanging control messages (execution instruction, stop instruction) through interprocess communication that is established with the running process or thread of the pre-acquisition. A step in which a process or thread to perform the pre-acquisition process is stopped depends on implementations. Similarly, in the case of implementation by hardware, can be implemented the processes for start and stop are implemented in the form of, for example, setting an Enable/Disable signal and turning on/off of an operation clock, and the methods thereof depend on implementations.

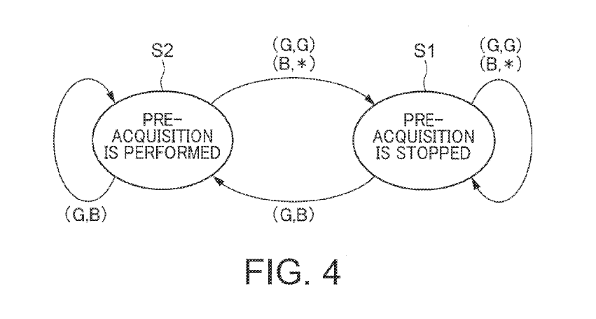

FIG. 4 shows a state transition diagram of the pre-acquisition operation in the communication apparatus 100 based on the flow chart of FIG. 3. There are a state S1 that is suitable for communication from a long-term perspective and a state S2 that is suitable for communication from a short-term perspective, and transitions between these states are shown.

Note that, in this drawing, the case where the short-term comprehensive evaluation value or the long-term comprehensive evaluation value is more than or equal to the reference value is denoted by “G,” the case where either thereof is less than the reference value is denoted by “B,” and the case where either thereof may be more than, less than, or equal to the reference value is denoted by “*,”. In addition, (X, Y) added to each transition indicates that X is the short-term comprehensive evaluation value, and Y is the long-term comprehensive evaluation value.

As shown in FIG. 4, when the transition to the state S2 suitable for communication from a short-term perspective is made, the pre-acquisition is started, or if the state S1 suitable for communication from a long-term perspective lasts, the pre-acquisition is stopped. By performing control in such a manner, it is possible to prevent information more than necessary from being subjected to the pre-acquisition in a state where the communication environment is stable, such as a situation of not leaving a side of a wireless LAN access point. As a result, it is possible to reduce traffic flowing in the network and to reduce energy consumption required for exchanges.

In the operation example shown by the flow chart of FIG. 3, only the communication environment is used to make the evaluation out of the communication environment and the apparatus state, but there will be described below the case where the evaluation is made using both the communication environment and the apparatus state. As a prerequisite, the controller 109 can grasp a power supplying state and distinguishes, using this function, the apparatus state of the communication apparatus between the case where continuous power supply such as commercial power source (AC adapter) is provided, and the case where temporal power supply such as a battery is provided.

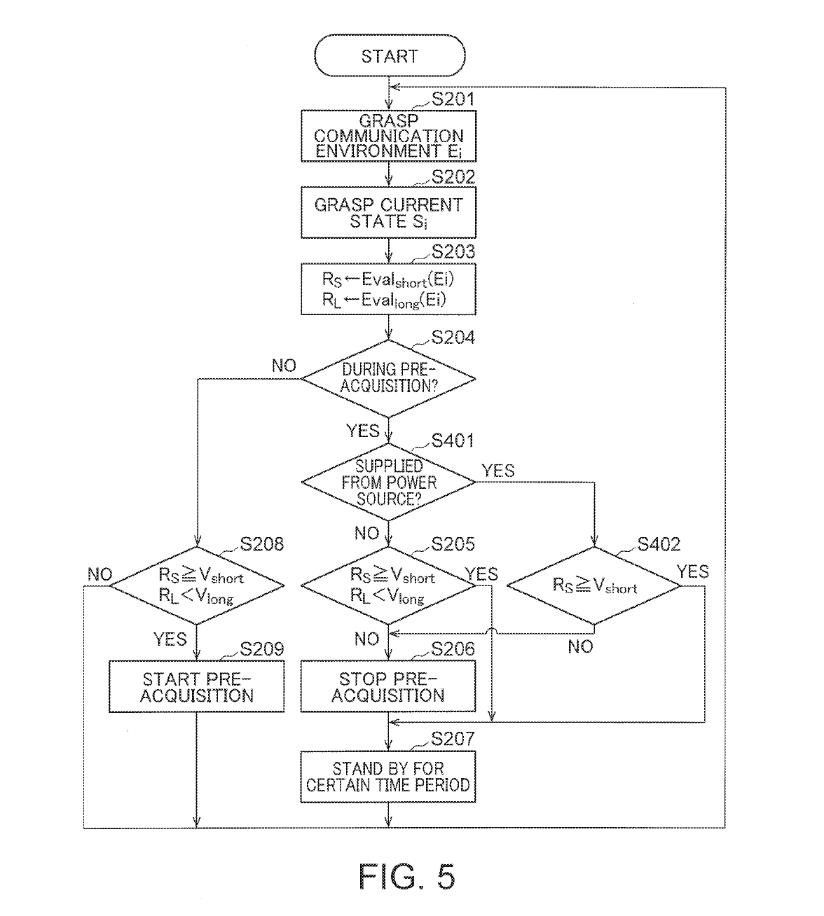

FIG. 5 shows a flow chart of a second operation example. Changes are made in steps S202, S401, and S402. In step S202, an apparatus state Sᵢ of the communication apparatus 100 is grasped.

In step S401, determination based on the power supplying state is made. If the power is supplied from a power source that can perform continuous supply such as a commercial power source (S401-YES), the flow proceeds to step S402. In the case of a power supply that cannot perform continuous supply such as a battery (S401-NO), the flow proceeds to step S205.

The process after the flow proceeds to step S205 is the same as the operation in FIG. 3 and will not be described.

In step S402, it is determined whether the short-term comprehensive evaluation value Rₛ is more than or equal to the reference value Vshort. If the short-term comprehensive evaluation value Rₛ is more than or equal to the reference value Vshort (S402-YES), the status quo (to continue the pre-acquisition) is determined, and after the standby for a certain time period (S207), the flow returns to the first step S201.

If the short-term comprehensive evaluation value Rₛ does not reach the reference value Vshort (S402-NO), the pre-acquisition is stopped (S206), and after the standby for a certain time period (S207), the flow returns to the first step S201.

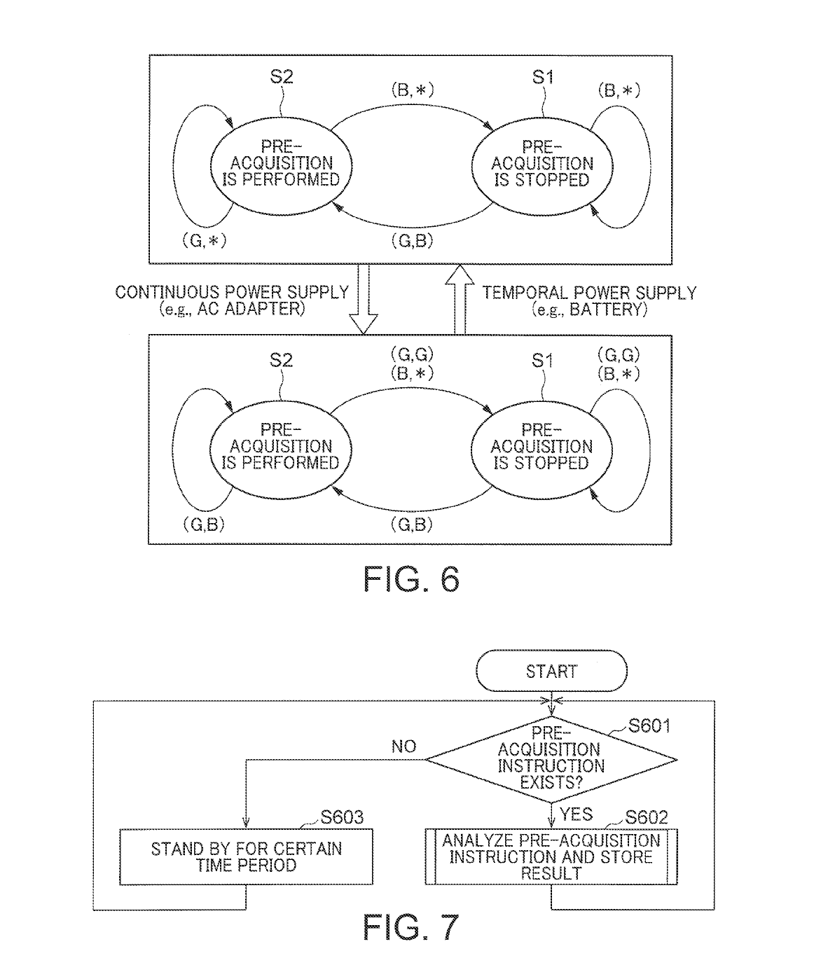

FIG. 6 shows a state transition diagram corresponding to the operation of FIG. 5. Unlike FIG. 4, there are two state transition diagrams each contain the state S1 suitable for communication from a long-term perspective and the state S2 suitable for communication from a short-term perspective, and these two state transition diagrams are switched to in accordance with the apparatus state of whether continuous power supply is provided.

As described above, according to the second operation example, in the case where power is supplied from a power source that cannot perform continuous supply such as a battery, when the transition to the state suitable for communication from a short-term perspective is made, the pre-acquisition is started, or when the state suitable for communication from a long-term perspective lasts, the pre-acquisition is stopped. By performing control in such a manner, it is possible to prevent information more than necessary from being subjected to the pre-acquisition in a state where the communication environment is stable, such as a situation of not leaving a side of a wireless LAN access point. As a result, it is possible to reduce energy consumption required for the pre-acquisition. In addition, in the case where power is supplied from a power source that can perform continuous supply such as a commercial power source, it is possible to continue the pre-acquisition when the communication environment is good in a stable manner, enabling more information to be saved in the storage 106.

In the above-mentioned first operation example in FIG. 3 and the second operation example in FIG. 5, only the communication environment is used to calculate the (short- and long-term) comprehensive evaluation values, but the apparatus state may by additionally used to calculate the comprehensive evaluation value. For example, an acceleration sensor may be used to calculate an acceleration as the apparatus state, the walking state of a user (e.g., walking, stop moving, running) is determined from in a plurality of (in a short- or long-term) past changes in acceleration, and a value that is obtained by adjusting, in accordance with the determination result, a score calculated based on the communication environment may be determined as a comprehensive evaluation value. For example, when a user is running, considering that the current communication environment highly likely changes, a score calculated based on the communication environment (e.g., a value ranging between 0 and 100) is adjusted to be smaller, which may be defined as the comprehensive evaluation value.

### (Detail of Pre-Acquiring Process)

The operation of the pre-acquisition unit 104 of the communication apparatus 100 will be described below in detail. The pre-acquisition unit 104 operates based on, as mentioned above, an instruction from the application running on the application executor 102 (pre-acquisition instruction), or an instruction from a communication destination apparatus in a network connected via the communication I/F 107 (pre-acquisition instruction). Alternatively, the pre-acquisition unit 104 may autonomously acquire information that may be referred to afterward without receiving an instruction from the application executor 102, by analyzing information that is acquired in response to a request from the application running on the application executor 102.

Here, the pre-acquisition instruction is: (1) an instruction given by notifying information relating to a memory area in which an identifier to specify information in a network (URL) is stored; (2) an instruction given by notifying information relating to a file in which the URL is stored; (3) an instruction given by notifying a message containing a group of IP packets and the like; and (4) an instruction given by notifying the URL of a file.

The above-described pre-acquisition instructions (1) and (2) are given by notification from the application executor 102 to the pre-acquisition unit 104 via the memory 105 or the storage 106.

That is, a conceivable method is one in which the application executor 102 secures a buffer in the memory 105, stores, in the buffer, URLs that is predicted to be accessed afterward, and notifies the position (pointer) of the buffer to the pre-acquisition unit 104. Similarly, the application executor 102 generates a file in the storage 106, stores the URLs in the file, and notifies the file to the pre-acquisition unit 104 in the forms of an instance such as a file name, a file descriptor, and a file class. The pre-acquisition instructions (3) and (4) are instructions that are received over a network, and basically similar to (1) and (2). That is, the instruction (3) is a method of receiving a pre-acquisition instruction in which information having a form described by (1) or (2) is divided into IP packets and transmitted over a network. The instruction (4) is a method of receiving a pre-acquisition instruction in which a URL to specify a file that is described in a form similar to the above-mentioned file is received over a network, and the communication apparatus 100 acquires the file using the URL.

Note that, a file describing a URL of the information to be acquired may be in any format as long as the format can be used by the communication apparatus 100. Conceivable formats include, for example, a text file (describing one URL in one row. e.g., CSV format, HTML format, XML format, CSS format), and a binary file obtained by subjecting the text file to predetermined manipulation (e.g., compression, encryption).

FIG. 7 is a flow chart of the operation of the pre-acquisition unit 104. When receiving a pre-acquisition instruction by any method described thus far (S601-YES), the pre-acquisition unit 104 analyzes the instruction (S602). Here, the analysis is a process to specify information to be acquired, for example, to extract a link (URL) from a text file that conforms to an HTML format and specify information on a link destination as the information to be acquired. If the pre-acquisition instruction is received in the form of being stored in the memory 105, analyzed information (link) may have been passed. In this case, the analyzing process may be skipped. In any case, a URL to acquire information is extracted and saved in the memory 105 or the storage 106 (S602). Note that if there is no pre-acquisition instruction (S601-NO), the pre-acquisition unit 104 continues to stand by and waits for a pre-acquisition instruction to come (S603).

This instruction on a URL to acquire information in advance may be added while performing the pre-acquisition. This can be supported by storing extracted URLs in the memory 105 in the form of a FIFO queue. Alternatively, this can be supported by adding the URLs to a file in the storage 106.

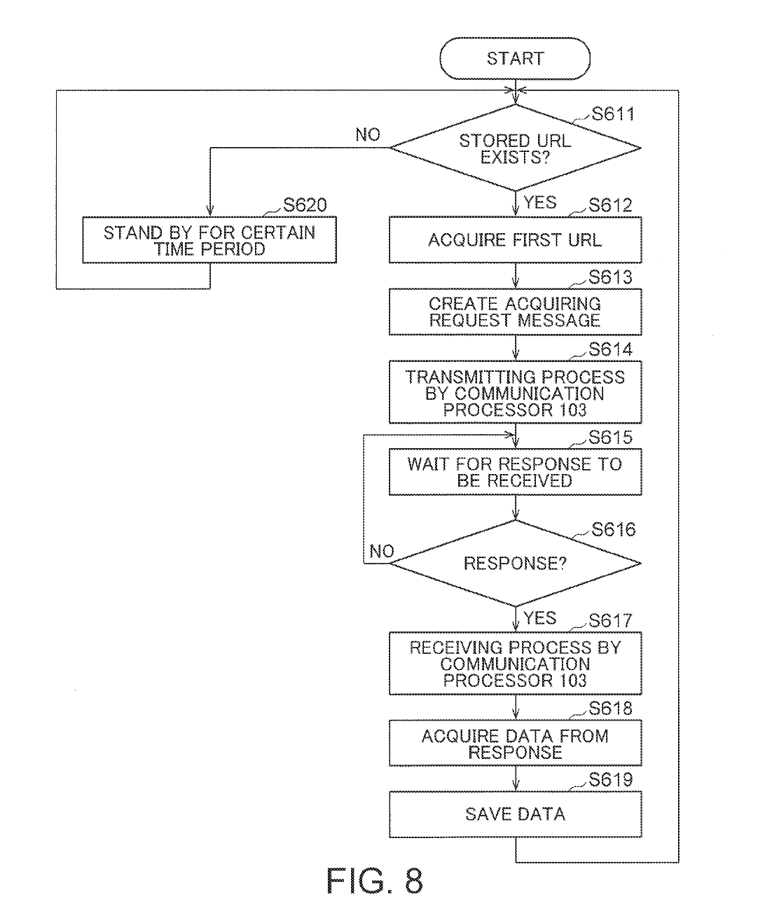

FIG. 8 is a flow chart of the detailed operation of step S602 in FIG. 7. The pre-acquisition unit 104 determines whether a URL to acquire information is saved in the memory 105 or the storage 106 (S611). If the URL is not saved, the pre-acquisition unit 104 stands by for a certain time period (S620), and the flow returns to step S611. In contrast, if the URL is saved, the following operation is performed independently of the operation by the application executor 102 (S611-YES).

The pre-acquisition unit 104 reads out the stored URL from the memory 105 or the storage 106 (S612), creates an acquiring request message under a communications protocol such as HTTP specified by a URL (S613), and thereafter, in order to perform a TCP/IP process, requests the process from the communication processor 103 (S614). This request can be considered to be, for example, an exchange of a message and control information via SocketAPI, and by executing an API such as send( ) to transmit an acquiring request message to a predetermined server.

The communication processor 103 properly processes the received acquiring request message under TCP/IP and thereafter transmits it to a predetermined server via the communication I/F 107. Thereafter, the server transmits back the required information, and a response arrives the pre-acquisition unit 104 via the communication I/F 107 and the communication processor 103 (S615, S616, S617, and S618). The pre-acquisition unit 104 associates data in the acquired response with an identifier to identify the information (e.g., URL) and saves the data in the memory 105 or the storage 106 (S619).

The pre-acquisition is enabled by repeatedly performing the above process on extracted URLs.

### (Relation Between Performing Pre-Acquiring Process and Acquisition Approval/Disapproval Determination by Controller 108)

Performing the series of pre-acquisition processes (the processes in FIG. 7 and FIG. 8) is restricted by acquisition approval/disapproval determination (the operations in FIG. 3 and FIG. 5) by the controller 108. As mentioned above, the pre-acquisition process and the acquisition approval/disapproval determination (the operations in FIG. 3 and FIG. 5) are independently performed, if the pre-acquisition process is implemented by software, performing the pre-acquisition can be interrupted at a convenience point in terms of implementation.

For example, the result of the acquisition approval/disapproval determination may be referred to with timing of performing step (S612) of reading out a URL to be acquired, and if the acquisition is disapproved, the subsequent process may not be performed (a determination process may be added prior to S612 so as to transit to step S620 and stands by for a certain time period if the pre-acquisition is disapproved). When this method is employed, performing and stopping the process can be implemented inside the pre-acquisition unit 104. However, controllable communication is only communication performed by the pre-acquisition unit 104.

In contrast, the implementation can be made so as to perform control not to transmit an issued acquiring request message to a network. In this case, the communication processor 103 is revised to refer to the result of the acquisition approval/disapproval determination in one of step immediately before the transmission to the communication I/F 107 and step of a communications protocol process, and the subsequent process may not be performed (in S614).

In the case of employing this method, the implementation is considered to be difficult because this method involves the alteration of a communications protocol process but to be able to control communication in a general-purpose manner.

Note that, as mentioned above, a method of performing and stopping the process can be implemented, in the case of software, by starting and stopping of a process or a thread, transitioning and returning to the stopping state of the process or the thread, and the like, or in the case of hardware, by turning on/off a clock, turning on/off power, and the like.

### (Supplemental Description: Short-Term Comprehensive Evaluation Value and Long-Term Comprehensive Evaluation Value, and how to Treat Reference Value)

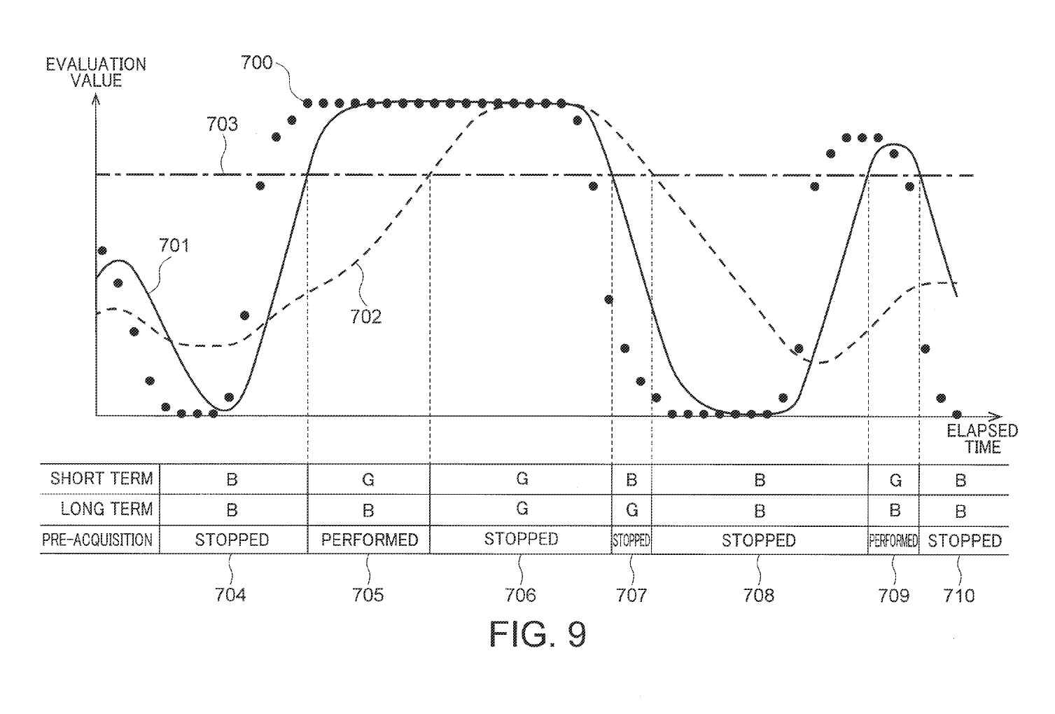

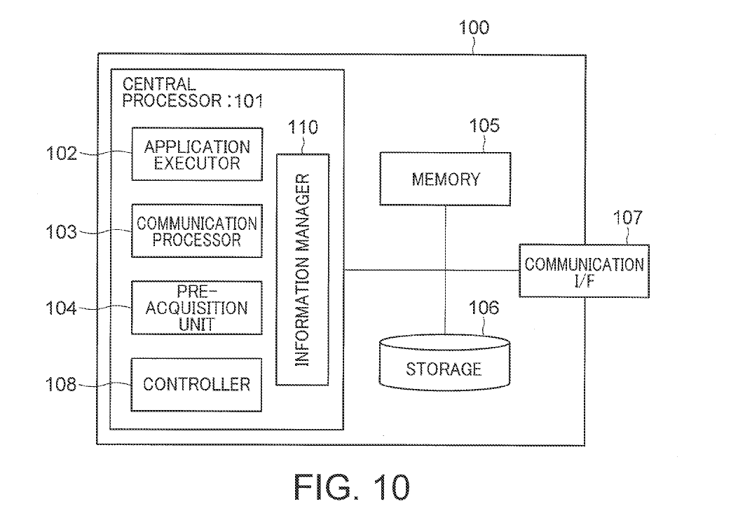

In the series of descriptions relating to the first embodiment, it is described that the short-term comprehensive evaluation value and the long-term comprehensive evaluation value are obtained using at least one of the communication environment Eᵢ and the apparatus state Sᵢ, and the evaluation functions Evalₛₕₒᵣₜ( ) and Eval_{long}( ). This part will be described more intuitively with reference to FIG. 9.

FIG. 9 is a diagram for illustrating a specific example of the operation of the first embodiment. FIG. 9 shows a series of raw data items (evaluation values) (700) that are acquired at every evaluation timing, a series of moving averages (short-term comprehensive evaluation values) (701) that are obtained from past five raw data item, a series of moving averages (long-term comprehensive evaluation values) (702) that are obtained from past 20 raw data items, and a reference value (703). The rows “short-term” and “long-term” on the lower side of FIG. 9 shows states with respect to a reference value (G represents exceeding the reference value, and B represents falling below the reference value). Here, the reference value is common to short- and long-term comprehensive evaluation values (Vshort=Vlong).

As having been already described, in the first embodiment, the state transition shown in FIG. 4 or FIG. 6 is performed. As shown in FIG. 9, when the magnitude relationship of the (long- or short-term) comprehensive evaluation value with respect to the reference value, according to the state transition diagram in FIG. 4 or FIG. 6, the performing state of a pre-acquisition function is as shown in the row “pre-acquisition” on the lower side of FIG. 9 (note that FIG. 9 is based on the state transition diagram of FIG. 4).

At first, both the long- and short-term comprehensive evaluation values are low, the pre-acquisition is stopped (interval 704), and the short-term comprehensive evaluation value is thereafter increased, the communication environment is determined to be stable to a certain extent, and the pre-acquisition is started (interval 705). Thereafter, both the short- and long-term comprehensive evaluation values are increased, it is determined that the stability of the communication environment for a long time is confirmed, and the pre-acquisition is stopped (interval 706). Thereafter, the communication environment deteriorates in the short term (the short-term comprehensive evaluation value is decreased) and further deteriorates also in the long term (the long-term comprehensive evaluation value is also decreased), and the pre-acquisition remains stopped (intervals 707 and 708). Thereafter, when the short-term comprehensive evaluation value is increased, the communication environment is determined to be stable to a certain extent even if the long-term comprehensive evaluation value remains low, and the pre-acquisition is started (interval 709), but thereafter the short-term comprehensive evaluation value is decreased again, the communication environment is determined to deteriorate, and the pre-acquisition is stopped (interval 710). Note that, by changing the length of an interval taken into account for the moving averages, it is possible to make adjustment so as to ignore very-short-term improvement (a state where the comprehensive evaluation value is improved only in a short time).

As described above, according to the first embodiment, the communication apparatus that acquires information over a network can detect an environment in which communication can be stably continued, while enjoying an advantage brought by the function of the pre-acquisition, and it is consequently possible to avoid the continuation of information acquisition without limit. In addition, in the use of temporal power supply means such as a battery, it is possible to combine advantages of the energy consumption and the pre-acquisition.

### Second Embodiment

In the first embodiment, at least one of a communication environment Eᵢ and an apparatus state Sᵢ is acquired to calculate a comprehensive evaluation value, and the approval/disapproval for pre-acquisition is determined. In contrast to this, in the present embodiment, the approval/disapproval for the pre-acquisition is determined also using the amount of data items that have been subjected to the pre-acquisition.

FIG. 10 shows a functional block diagram of a communication apparatus in which an information processing device in a second embodiment is installed. Components having the same names as in FIG. 1 will be denoted by the same reference numerals. An information manager 110 is added to the central processor 101 of the communication apparatus shown in FIG. 1. The other parts perform the same operations as those in the first embodiment except for matters described below. An information manager 110 can be implemented by circuitry such as a processor or an integrated circuit. The circuitry which implements the information manager 110 may be different physical circuitry from those implementing the elements 101, 102, 103, 104 and 108, or all or a part of the elements 101, 102, 103, 104, 108 and 110 may be same physical circuitry such as a CPU.

The information manager 110 manages statistical information relating to information that is subjected to pre-acquisition. The statistical information includes, for example, the number or size of pieces of information that are subjected to the pre-acquisition by the pre-acquisition unit 104 and saved in the memory 105 or the storage 106, the number of times, the size, or the rate of pre-acquisition instructions from the application executor 102, the number of times, the size, or the rate of making references by the application executor 102 and succeeded responses to the application executor 102 using information in the memory 105 or the storage 106, and the size or the rate of information that is subjected to the pre-acquisition but is not referred to. By making access to information to be/having been stored from the pre-acquisition unit 104 and the application executor 102 into the memory 105 or the storage 106 via the information manager 110, the information manager 110 can manage these pieces of statistical information.

Note that it is assumed that the size of information, out of a size requested by the application executor 102, that cannot be acquired from the memory 105 or the storage 106 is separately notified from the application executor 102. Note that the acquisition of information that cannot be acquired from the memory 105 and the storage 106 can be implemented in such a manner as to cause the information manager 110 to take over part of the operation of an application running on the application executor 102, such that the information manager 110 acquire the information from a communication destination. In this case, the information manager 110 is allowed to grasp, by itself, the size of information that cannot be acquired from the memory 105 or the storage 106 out of the size requested by the application executor 102.

Hereafter, the description will be made assuming that the information manager 110 manages the size of information subjected to the pre-acquisition by the pre-acquisition unit 104 and the size of information requested by the application executor 102, and the size of information that is actually read out from the memory 105 or the storage 106.

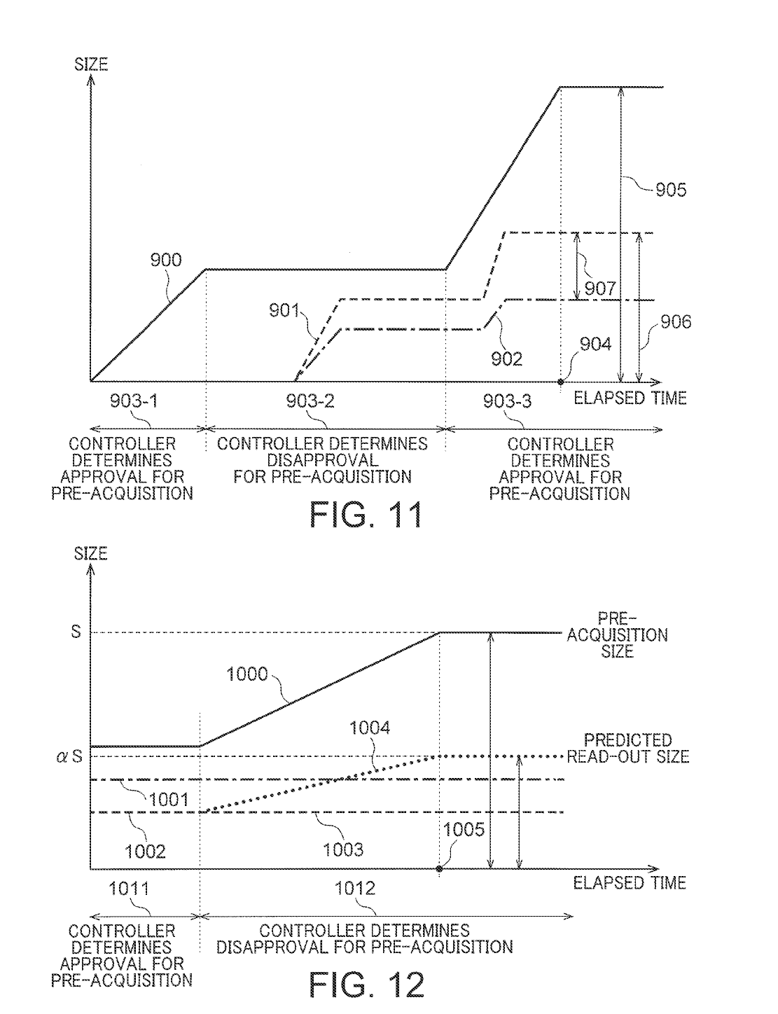

Based on this assumption, a specific example of the operation in the second embodiment will be described with reference to FIG. 11. In the following description, it is assumed that “a rule of control is set providing that the pre-acquisition is approved information having twice a size requested by the information manager 110, or disapproved for information having a further size.”

FIG. 11 shows three graphs. The horizontal axis represents the elapsed time, and the vertical axis represents the size. A graph 900 represents the total size of pieces of information that the pre-acquisition unit 104 has acquired thus far (when the starting point is the origin), a graph 901 represents the total size of pieces of information that the application executor 102 has requested thus far, and a graph 902 represents the total size of pieces of information that have been read out from the memory 105 and the storage 106 in response to requests from the application executor 102.

Under the axis of elapsed time, intervals 903-1 to 903-3 are shown, the intervals 903-1 to 903-3 representing determination results of the approval/disapproval for the pre-acquisition in the respective time period. The determination results in the intervals 903-1 to 903-3 are determination results by the controller 108, being determined based on at least one of the environment and the apparatus state described in the first embodiment. In addition, in this drawing, a relationship (total size of pre-acquisition)>(total requested size)>(total read-out size) is always held, from which it is found that information subjected to the pre-acquisition is read out, but some pieces of information are directly acquired from the communication destination. This drawing is merely an example, and a relationship different from this relationship may be held (e.g., in the case where more than the amount of information subjected to the pre-acquisition is requested by the application executor 102). Furthermore, increasing rates in each graph (=total size/elapsed time) in FIG. 11 are also merely an example, and the increasing rates actually change due to variations in the state of a network or frequency of requests made in the application executor 102, and the like, and the changes may be stepwise (discontinuous) depending on implementations.

In the interval 903-1, the pre-acquisition is approved by the controller 108, and as shown by the graph 900, the total size of the pre-acquisition is increased. At the phase of entering the interval 903-2, the pre-acquisition is disapproved by the controller 108, and the graph 900 becomes unchanged. A request is made from an application (application executor 102) in the middle of the interval 903-2, and the graph 901 and the graph 902 increase. It is assumed here that part of data requested by the application executor 102 can be read out from one of the memory 105 and the storage 106. When the fulfillment of the request from the application executor 102 is completed, and no new request is made thereafter, the graph 901 and the graph 902 stop changing.

At the time when entering the interval 903-3 and the pre-acquisition is approved again by the controller 108, the value of the graph 900 increases. In the middle of the interval 903-3, a request is made from the application executor 102, and the graph 901 and the graph 902 temporarily increase. Meanwhile, the graph 900 stops changing at an elapsed time 904. This is because the pre-acquisition turns disapproved under control by the information manager 110 in the present embodiment (as assumed above, the size of information subjected to the pre-acquisition (shown by a line 905 with a two-directional arrow) reaches twice the total size of information requested by the application executor 102 (shown by a line 906 with a two-directional arrow)). That is, even if the pre-acquisition is approved by the controller 108, the pre-acquisition is determined to be disapproved by the information manager 110, the pre-acquisition is disapproved as a determination result as a whole. Note that a line 907 with a two-directional arrow represents the difference between the total size requested by the application executor 102, and the total size read out from the memory 105 and the storage 106.

In such a manner, in the second embodiment, the determination of approval/disapproval for the pre-acquisition is made using the determination of the approval/disapproval for the pre-acquisition in the first embodiment, as well as statistical information relating to the size and the like of information subjected to the pre-acquisition, and both the determination results thereof are used. The pre-acquisition is approved only if both the determination results indicate approval. If one of the results indicates disapproval, the pre-acquisition is not approved.

By performing in such a manner, it is possible to control the amount of information to be subjected to the pre-acquisition more intuitively, which in turn leads to the reduction of consumed energy. In addition, the pre-acquisition is performed to some extent, it is possible to balance with convenience. Note that the condition described here is merely an example, not limited to “twice,” and not limited to “the relationship between the total size of information subjected to the pre-acquisition and the total size of requested information” either. The relationship may be “the relationship between the total size of information subjected to the pre-acquisition and the total size of read-out information,” or “the relationship between the total size of requested information and the total size of read-out information.” Alternatively, the number of times, the number of pieces of information, or a rate (e.g., a reading-out rate to information subjected to the pre-acquisition) may be used rather than a size.

However, the reading-out rate to the information subjected to the pre-acquisition decreases as the pre-acquisition is performed more, and thus in the case where the determination of approval/disapproval for pre-acquisition is made using the reading-out rate as a condition, a predicted value of the reading-out rate to the amount of pre-acquisition is needed. That is, the approval/disapproval for the pre-acquisition needs to be determined by determining the predicted total read-out size assuming that, when X bytes of pre-acquisition is performed in total, αX bytes of information will be read-out afterward, where αX is obtained by multiplying X by α being a probability. FIG. 12 schematically shows how the approval/disapproval for the pre-acquisition is determined in such a manner, as another specific example of the operation in the second embodiment. There are shown a graph 1000 representing the total size that has been subjected to the pre-acquisition, a graph 1001 representing the total size requested by the application executor, and a graph 1002 representing the total read-out size. In an interval 1011, the pre-acquisition is determined to be disapproved by the controller 108, and in an interval 1012, the pre-acquisition is determined to be approved by the controller 108.

In FIG. 12, the pre-acquisition is started with timing of starting the interval 1012, and the value of the graph 1000 representing the total acquired size increases. In contrast, the value of the graph 1001 representing the total requested size is unchanged because no request is made from the application executor 102.

Naturally, the value of the graph 1002 representing the total read-out size is also unchanged, but a future read-out size is calculated assuming that the information subjected to the pre-acquisition is read out at the probability a. A graph 1004 shown by a dotted line represents the future read-out size. At the phase where this future read-out size reaches a predetermined size (here, as) (at an elapsed time 1005), the pre-acquisition is finished. The pre-acquisition remains approved by the controller 108 but is stopped under the determination by the information manager 110.

In the series of descriptions, there has been described the case where the pre-acquisition is stopped under the determination by the information manager 110, the pre-acquisition can be started under the determination by the information manager 110. For example, in the case of responding a request from an application in the situation where information requested by the application is not subjected to the pre-acquisition, the rate of response using the information subjected to the pre-acquisition decreases. The information manager 110 may perform control so as to approve the pre-acquisition if this value falls below a given threshold value.

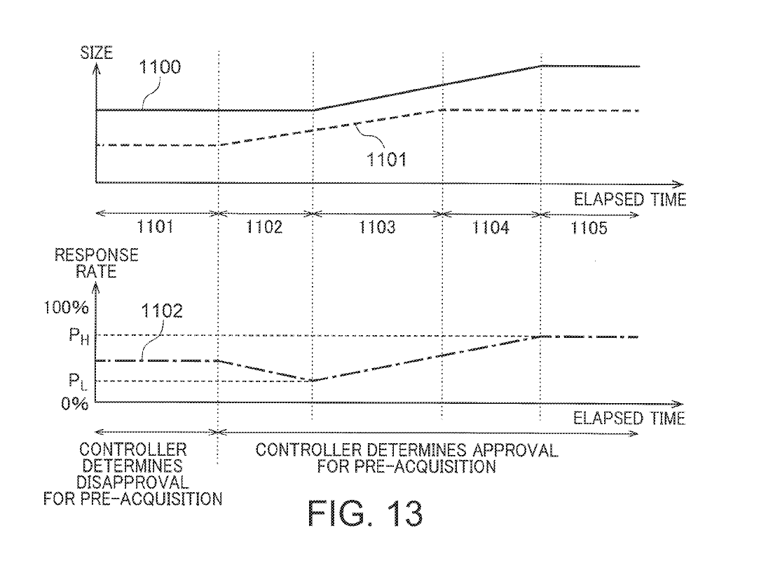

Still another specific example of the operation in the second embodiment will be described with reference to FIG. 13. FIG. 13 is a diagram for illustrating an example of controlling performing and stopping the pre-acquisition using a lower limit P_{L} and an upper limit P_{H} being threshold values in the case where the information manager 110 manages a ratio at which a response to a request from the application executor 102 can be made with information subjected to the pre-acquisition. Any method can be used to determine P_{L} and P_{H}, and a conceivable method is, for example, using the above-mentioned response rate or the reading-out rate. FIG. 13 shows, on the upper side thereof, a graph 1100 representing the total size subjected to the pre-acquisition and a graph 1101 representing the total size requested by the application executor 102, and FIG. 13 shows, on the lower side thereof, a graph 1102 representing the response rate.

In an interval 1101, the pre-acquisition is disapproved under the determination by the controller 108, and the pre-acquisition is approved in an interval 1102 or later. In the interval 1102, the pre-acquisition is approved but not performed yet. This is because the restart of the pre-acquisition is reserved (stopped) by the information manager 110. In this phase, the pre-acquisition is not restarted because a response rate P to the total size subjected to pre-acquisition is larger than or equal to the lower limit threshold value P_{L}, and the pre-acquisition is considered to have an effect. In contrast, assume that data is read out by a request from the application executor 102. At this point, assuming that much data cannot read out from the data subjected to the pre-acquisition and a large size of data is directly acquired over a network, the response rate decreases. At last, the response rate reaches the lower limit P_{L} at the boundary between the interval 1102 and the interval 1103. Taking this opportunity, in an interval 1103 to an interval 1104, the reservation of the pre-acquisition by the information manager 110 is canceled, and the pre-acquisition is performed. Performing the pre-acquisition increases information having a potential to be used as a response, the response rate can be considered to recover gradually. At last, the response rate reaches the upper limit value P_{H} between the interval 1104 and the interval 1105, and thus the pre-acquisition is finished.

As describe above, according to the second embodiment, to perform or stop the pre-acquisition is managed under the management by the information manager 110. Since the pre-acquisition and reading out of information are managed by the information manager 110, it is possible to perform control taking into consideration the amount of data subjected to the pre-acquisition or the response rate of information subjected to the pre-acquisition. For this reason, it is possible to achieve fine control as compared with the first embodiment, efficiently achieving the combination of energy reduction and convenience.

### Third Embodiment

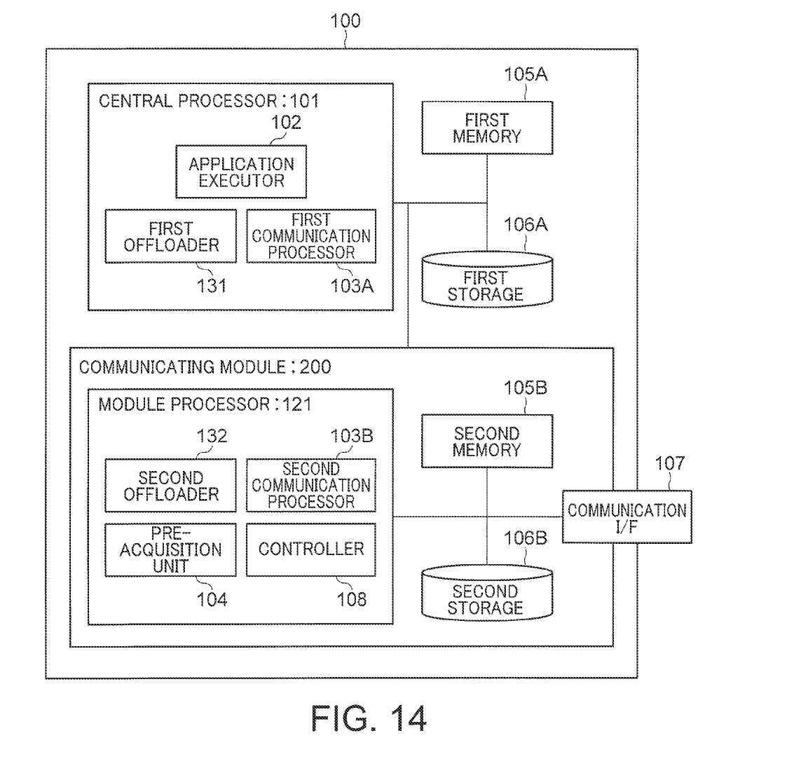

FIG. 14 shows a functional block diagram of a communication apparatus in which an information processing device in a third embodiment is installed. Unlike the embodiment thus far, a communicating module 200 is installed in the communication apparatus. Communication processors, memories, and storages exist on both the central processor 101 side (host side) and the communicating module 200 side, and thus they are named using “first” and “second,” respectively. That is, on the host side, they are referred to a first communication processor 103A, a first memory 105A, a first storage 106A, and on the communicating module side, they are referred to a second communication processor 103B, a second memory 105B, and a second storage 106B. The pre-acquisition unit 104 and the controller 108 described in the first and second embodiments are included in the communicating module 200. In addition, the functions of the communication processor, memory, and storage described in the first and second embodiments are mainly implemented by the second communication processor 103B, the second memory 105B, and the second storage 106B in the third embodiment.

The central processor 101 includes the application executor 102 and the first communication processor 103A, as well as a first offloader 131. The first offloader 131 has charge of a pre-process/post-process for offloading (delegating) the whole or a part of a communication process performed by applications running on the application executor 102 or the first communication processor 103A, to the communicating module 200.

For example, in the case where a communicating application such as a web browser and a RSS reader that acquires information using HTTP runs on the application executor 102, the process of a communications protocol and communication in TCP/IP itself accompanying the acquisition can be offloaded to the communicating module 200. To offload them, the application executor 102 notifies an acquiring request for information to the second offloader 132. The second offloader 132 offloads the process of the application or communicating process under a format that is defined in advance with the second offloader 132 added to the communicating module 200.

The communicating module 200 includes the second memory 105B, the second storage 106B, and the communication I/F 107, as well as a module processor 121. The module processor 121 includes the second communication processor 103B, the pre-acquisition unit 104, and the controller 108, as well as the second offloader 132. The second offloader 132 receives, from the first offloader 131, a notification having the contents of a process to be offloaded, and gives an instruction to the pre-acquisition unit 104 or the second communication processor 103B in accordance with the notification. Specifically, the instruction is given to the pre-acquisition unit 104 in the case of the above-mentioned acquiring request for information using HTTP, or the instruction is given to the second communication processor 103B in the case of a mere request for communicating process. Note that there may be duplicated process between the first communication processor 103A and the second communication processor 103B in terms of function, and the process performed by the first communication processor 103A may not be performed by the second communication processor 103B. For example, if an IP header is created by the first communication processor 103A, the second communication processor 103B performs a corresponding routing process and processes up to the Layer 2. If all the processes up to the Layer 3 are completed by the first communication processor 103A, it is possible that the second communication processor 103B only makes transfer to the communication I/F 107 as it is.

The process notified to the pre-acquisition unit 104 via the second offloader 132 is processed in a manner described in the first or second embodiment. As a result, acquired information is accumulated in the second memory 105B or the second storage 106B. At the time when the result of processing by the pre-acquisition unit 104 is transmitted to the central processor 101 via the second offloader 132 as a response, this information may be copied or move to the first memory 105A or the first storage 106A together with the information. Instead of these operations, means for accessing information recorded in the second memory 105B or the second storage 106B (e.g., information with which the location or length of information saved in the second memory 105B or the second storage 106B can be specified, such as a file name, a sector position, and an address) may be transmitted as a response together with a response of the result of processing.

In this case, the central processor 101 accesses information in the second memory 105B or the second storage 106B in the communicating module 200, by way of appropriate means.

Note that, FIG. 14 shows that the first communication processor 103A exists in the central processor 101, but a configuration without this first communication processor is possible. In this case, the central processor 101 may not perform the communicating process but instruct the first offloader 131 to request an information acquiring process and receive a response thereto from the first offloader 131.

Furthermore, in FIG. 14, the first offloader 131 and the second offloader 132 cooperate with each other to exchange information relating to an instruction or a response accompanying the pre-acquisition or the offloading process. As a modification thereof, a configuration without the first offloader 131 and the second offloader 132 is possible. In this case, a packet transmitted or received by the first communication processor 103A may be acquired in the communicating module 200 (e.g., by the second communication processor 103B), the contents thereof may be analyzed and an acquiring request for information is detected, and the acquiring request may be transferred to the pre-acquisition unit 104. At this point, the pre-acquisition unit 104 can operate without having an influence on an application running on the central processor 101 by acting, for example, as a transparent proxy server. The pre-acquisition unit 104 may operate in such a manner as to transmit, if any, information that has been subjected to the pre-acquisition in response to the acquiring request for information, or otherwise, newly acquire the information. At this point, by newly subjecting relevant information to the pre-acquisition, it is possible to implement an operation similar to that in the first and second embodiments.

In FIG. 14, the central processor 101, an application executor 102, the first communication processor 103A and the first offloader 131 can implemented by circuitry such as a processor or an integrated circuit. Each circuitry which implements the central processor 101, an application executor 102, the first communication processor 103A and the first offloader 131 may be different physical circuitry or all or a part of them may be same physical circuitry such as a CPU. The central processor 101 may be processing circuitry in which an application executor 102, the first communication processor 103A and the first offloader 131 are implemented.

The central processor 101, the application executor 102, the first communication processor 103A and the first offloader 131 can implemented by circuitry such as a processor or an integrated circuit. Each circuitry which implements the central processor 101, the application executor 102, the first communication processor 103A and the first offloader 131 may be different physical circuitry or all or a part of them may be same physical circuitry such as a CPU. The central processor 101 may be processing circuitry in which the application executor 102, the first communication processor 103A and the first offloader 131 are implemented.

The module processor 121, the second communication processor 103B, the second offloader 132, the pre-acquisition unit 104 and the controller 108 can implemented by circuitry such as a processor or an integrated circuit. Each circuitry which implements the module processor 121, the second communication processor 103B, the second offloader 132, the pre-acquisition unit 104 and the controller 108 may be different physical circuitry or all or a part of them may be same physical circuitry such as a CPU. The module processor 121 may be processing circuitry in which the second communication processor 103B, the second offloader 132, the pre-acquisition unit 104 and the controller 108 are implemented. The storage 106A and 106B may be configured by any storage device such as a memory or storage. The memory may be volatile memory such as SRAM or DRAM, or non-volatile memory such as NAND, FRAM or MRAM. The storage may generally be any device which can memorize data permanently such as an HDD, an optical disc or SSD. The term “circuitry” may indicate one circuit, a plurality of circuits, or a system of circuits.

As described above, according to the third embodiment, by implementing the pre-acquisition unit and the controller in the communicating module that is independent of the central processor 101, it is possible to implement the pre-acquisition function in an independent manner, enabling the reduction of a load on the central processor 101 and the minimization of an influence on conventional application or the like running on the central processor. In addition, the pre-acquisition function can be used in an existing apparatus by adding hardware as a module and installing software thereto.

### Fourth Embodiment

In the present embodiment, there will be described a form in which components in a communication apparatus are powered off or brought into a low-power-consuming state when not in use. The description will be made here taking the communication apparatus in the third embodiment by way of example, but this form can be similarly practiced in the communication apparatuses in the first and second embodiments.

As mentioned above, in the third embodiment, an instruction and a response are basically exchanged between the first offloader 131 and the second offloader 132. By adding, before or after this operation, a signal to change the operating state of the communicating module 200, the central processor 101, or a host unit including the central processor 101, the alteration of an operating state can be implemented. This enables the entire communication apparatus to be configured such that the communicating module 200 is energized or brought into the operating state only in communication and pre-acquisition and is powered off or transitions to a low-power-consuming state when these operations are finished. Note that the communicating module 200 itself may determine and spontaneously perform powering off or transitioning to the low-power-consuming state, or the central processor 101 on the host side may detect the completion of receiving a response and instruct the communicating module 200 to perform the state transition.

Similarly, the central processor 101, or the host unit including the central processor 101, the first memory 105A, or the first storage 106A may be configured to be powered off or transition to the low-power-consuming state in the state where the communicating module 200 is operating (e.g., during the pre-acquisition), and to be powered on or transition to the operating state when the operation by the communicating module 200 is completed. In general, some hardware interrupt signal is used as a return signal from the communicating module 200, but predicting a time point at which the process by the communicating module 200 is finished, the return may be made using a timer to which the value of the time point is set in advance. Alternatively, the return may be made using the other means such as a timer to which a fixed value is set.

As described above, according to the fourth embodiment, it is possible to further reduce the power consumption of the entire apparatus by performing the transition to the low-power-consuming state while the central processor 101, the host unit including the central processor 101 and the like, or the communicating module 200 is not operating.

### Fifth Embodiment

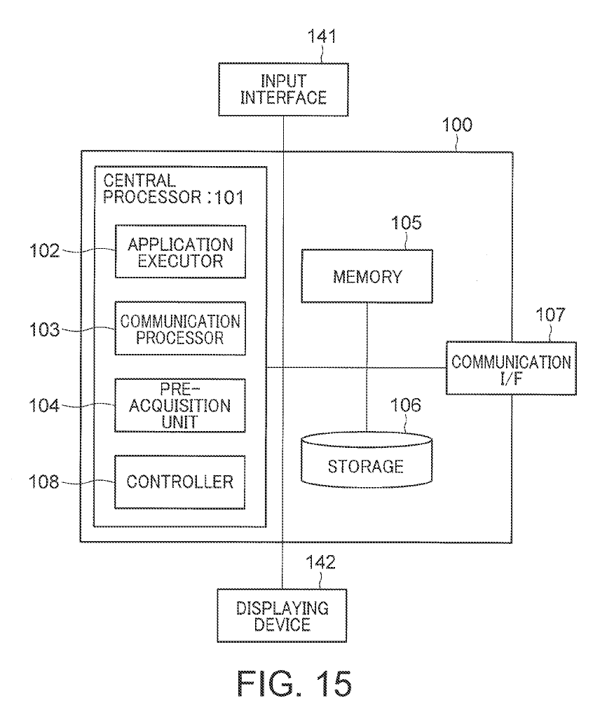

FIG. 15 shows a terminal in which an information processing device in a fifth embodiment is installed. This terminal is formed by adding an input interface 141 and a displaying device 142 to the communication apparatus in the first embodiment. The input interface 141 is an interface for user input, and the examples thereof include a keyboard, a mouse, a touch panel, and the like. The displaying device 142 displays data stored in the memory 105 in the form of an image. The displaying device 142 may be any device such as, for example, a liquid crystal display panel, a CRT panel, an organic EL panel, and an electronic paper, as long as it can display an image. In addition, an auxiliary storage device such as a hard disk and an SSD may be additionally connected. The terminal shown in FIG. 15 may be any device having a communicating function, such as a personal computer (PC), a laptop PC, a tablet terminal, a smartphone, a wearable device, and a camera. In the second to fourth embodiments, the terminal can be similarly configured by adding the input interface and the displaying device.

The information processing device, the communication apparatus and the terminal as described above may also be realized using a general-purpose computer device as basic hardware. That is, each function block (or each section) in the information processing device, the communication apparatus and the terminal can be realized by causing a processor mounted in the above general-purpose computer device to execute a program. In this case, the information processing device, the communication apparatus and the terminal may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information.

The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

The term “storage” may generally encompass any device which can memorize data permanently by utilizing magnetic technology, optical technology or non-volatile memory such as an HDD, an optical disc or SSD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing device comprising:
a first circuitry to specify information potential to be requested by an application and to acquire the information over a network before the information is requested by the application; and
a second circuitry to control operation of the first circuitry based on a parameter value obtained by measuring a surrounding communication environment or an evaluation value depending on the parameter value.

2. The information processing device according to claim 1, wherein the second circuitry determines, based on the parameter value or the evaluation value, whether the surrounding communication environment is suitable for communication, and stops the operation of the first circuitry when the environment suitable for communication lasts for a certain time period.

3. The information processing device according to claim 2, wherein the second circuitry causes the first circuitry to operate when the surrounding communication environment transitions from an environment unsuitable for communication to the environment suitable for communication and is the environment suitable for communication for a first time length, and causes the first circuitry to stop operating when the surrounding communication environment is the environment suitable for communication for a second time length that is longer than the first time length.

4. The information processing device according to claim 3, wherein
when an average of parameter values or an average of evaluation values, that are acquired during a time period having the first time length, is not less than or not more than a threshold value, it is determined that the surrounding communication environment is the environment suitable for communication for the first time length, and
when an average of parameter values or an average of evaluation values, that are acquired during a time period having the second time length, is not less than or not more than the threshold value, it is determined that the surrounding communication environment is the environment suitable for communication for the second time length.

5. The information processing device according to claim 2, wherein the second circuitry determines which of a first power source or a second power source that is able to supply power longer than the first power source power is supplied from, and when receiving supply of power from the second power source, the second circuitry does not stop the operation of the first circuitry even when the environment suitable for communication lasts for the certain time period.

6. The information processing device according to claim 1, further comprising
a third circuitry to manage statistical information relating to a plurality of pieces of information that are acquired by the first circuitry, wherein
the third circuitry determines, based on the statistical information, whether to approve operation of the first circuitry,
the second circuitry determines, based on the parameter value or the evaluation value, whether to approve the operation of the first circuitry, and
the operation of the first circuitry is controlled based on a determination result from the third circuitry and a determination result from the second circuitry.

7. The information processing device according to claim 6, wherein
the statistical information contains at least one of:
(1) a number of pieces of information that are acquired by the first circuitry, or a size of the information;
(2) a number of times or a size of instructions of pre-acquisition from the application in the case where the first circuitry is instructed to perform the pre-acquisition by the application;
(3) a number of times, a size, or a rate of responses that is able to be done using information acquired by the first circuitry when an acquiring request is made by the application; and
(4) a number of pieces, a size, or a rate of information for which an acquiring request is not made by the application, out of pieces of information acquired by the first circuitry.

8. The information processing device according to claim 7, wherein the third circuitry determines whether to approve the operation of the first circuitry, by comparing a value based on the statistical information with a threshold value corresponding to the statistical information.

9. The information processing device according to claim 7, wherein the third circuitry determines whether to approve the operation of the first circuitry based on relationship between values relating to at least two of the items (1) to (4).

10. The information processing device according to claim 6, wherein the first circuitry acquires the information only when being approved by both of the second circuitry and the third circuitry.

11. A communication apparatus comprising:
the information processing device according to claim 1; and
a communication interface to perform wireless communication with the network.

12. A terminal comprising:
the information processing device according to claim 1;
a communication interface to perform wireless communication with the network;
a memory to store data that is acquired by the first circuitry;
an input interface for user input to give an instruction to the information processing device; and
a displaying device to display data in the memory in a form of an image.

13. An information processing method performed by a computer, comprising:
specifying information potential to be requested by an application and to acquire the information over a network before acquisition of the information is requested by the application; and
controlling operation of acquiring the information based on a parameter value obtained by measuring a surrounding communication environment or an evaluation value depending on the parameter value.

14. A non-transitory computer readable medium having a computer program stored therein which causes a computer when executed by the computer, perform processes comprising:
specifying information potential to be requested by an application and to acquire the information over a network before acquisition of the information is requested by the application; and
controlling operation of acquiring the information based on a parameter value obtained by measuring a surrounding communication environment or an evaluation value depending on the parameter value.
